(19) United States
(12) Patent Application Publication
(10) Pub. No.: US 2023/0410194 A1
(43) Pub. Date: Dec. 21, 2023

(54) APPARATUS AND METHOD FOR DETERMINING THE CAPACITY OF INTERNATIONAL STUDENTS OR SCHOLARS TO PAY FOR HOUSING IN THE UNITED STATES

(71) Applicant: HUGS INTERNATIONAL CORPORATION, San Diego, CA (US)

(72) Inventor: Carl-Olivier DUMESLE, San Diego, CA (US)

(73) Assignee: HUGS INTERNATIONAL CORPORATION, San Diego, CA (US)

(21) Appl. No.: 18/333,382

(22) Filed: Jun. 12, 2023

Related U.S. Application Data
(60) Provisional application No. 63/353,191, filed on Jun. 17, 2022.

(51) Int. Cl. G06Q 40/03

(52) U.S. Cl. CPC G06Q 40/03

(57) ABSTRACT

A method for automatically determining a financial capacity of an international student, scholar, and/or other individual who is attending and/or otherwise associated with an educational institution in the United States and has little or no domestic credit history. The method is configured to assist the international student, scholar, and/or other individual in securing housing with landlords who would otherwise have limited resources for determining the financial capacity of the international student, scholar, and/or other individual. The automatic determination may be performed by a trained electronic financial capacity machine learning algorithm. The financial capacity machine learning algorithm is executed by one or more processors of a computing device.

### CROSS-REFERENCE TO RELATED APPLICATION

This Patent Application takes priority from U.S. Provisional Application No. 63/353,191, titled APPARATUS AND METHOD FOR DETERMINING THE CAPACITY OF INTERNATIONAL STUDENTS OR SCHOLARS TO PAY FOR HOUSING IN THE UNITED STATES, filed on Jun. 17, 2022, the contents of which are expressly incorporated herein by this reference as though set forth in its entirety and to which priority is claimed.

### BACKGROUND

### 1. Field

The present disclosure relates generally to automatically determining a financial capacity of an international student, scholar, and/or other individual who is attending and/or otherwise associated with an educational institution in the United States and has little or no domestic credit history.

### 2. Description of the Related Art

Most international students or scholars, when they move to the United States for school or work, do not have traditionally established credit (e.g., no credit score or other indicator associated with financial reliability). This lack of traditionally established credit becomes a problem when these individuals start looking for housing, because traditionally established credit is evaluated by landlords to determine whether an individual is likely to reliably pay rent, for example. Current electronic systems (e.g., foreign banking systems, U.S. government databases, etc.) that might be used to obtain financial information about these international individuals is disparate, and can be difficult for an average landlord to access, if such systems exist at all.

### SUMMARY

The following is a non-exhaustive listing of some aspects of the present techniques. These and other aspects are described in the following disclosure.

Automatically determining a financial capacity of an international student, scholar, and/or other individual who is attending and/or otherwise associated with an educational institution in the United States and has little or no domestic credit history is described. The systems and methods described herein are configured to assist the international student, scholar, and/or other individual in securing housing with landlords who would otherwise have limited resources for determining the financial capacity of the international university student, scholar, and/or other individual. The automatic determination may be performed by a trained electronic financial capacity machine learning algorithm. The financial capacity machine learning algorithm is executed by one or more processors of a computing device.

Some aspects include a process for determining a financial capacity of an international student or scholar. The process comprises training an algorithm using input output training pairs that describe prior financial information, prior visa information, prior student type information, and/or prior housing payment history information, for a population of international students and/or scholars affiliated with educational institutions in the United States. The process comprises inputting new financial information, new visa information, and/or new student type information for the international student or scholar to the algorithm. The process comprises determining, with the algorithm, relational data indicative of the financial capacity for the international student or scholar based on the new financial information, new visa information, and/or new student type information. The process comprises determining, with the algorithm, based on the relational data, the new financial information, the new visa information, and/or the new student type information, the financial capacity of the international student or scholar to pay for housing in the United States while the international student or scholar is affiliated with an educational institution.

In some embodiments, the process further comprises receiving, with the algorithm, later payment information for the international student or scholar indicating whether payments for the housing in the United States while the international student or scholar is affiliated with the educational institution have been made; and iteratively updating, based on the later payment information, the training of the algorithm, such that the determining of the financial capacity of the international student or scholar to pay for housing in the United States while the international student or scholar is affiliated with the educational institution is automatically personalized for the international student or scholar over time.

In some embodiments, determining the financial capacity of the international student or scholar to pay for housing in the United States while the international student or scholar is affiliated with the educational institution comprises determining a score.

In some embodiments, the new financial information is weighted heaviest, the new visa information is weighted second heaviest, and the new student type information is weighted third heaviest by the algorithm for the determination of the financial capacity.

In some embodiments, the new financial information comprises information from a Form I-20, a bank balance, scholarship information, sponsorship information, and/or employment information for the international student or scholar.

In some embodiments, the new visa information comprises a visa type, a visa validity period, and/or a university program period for the international student or scholar.

In some embodiments, the new student type information comprises an indication of whether the international student or scholar is an undergraduate or graduate student, and/or an indication of whether the international student or scholar is new versus transferring or continuing.

In some embodiments, the relational data comprises an indication of whether the international student or scholar is permitted to work, whether a visa validity period is longer than a university program period, and/or whether the international student or scholar has excess funding compared to that required for attending university in the United States.

In some embodiments, the algorithm comprises a machine learning algorithm. In some embodiments, the machine learning algorithm comprises a neural network.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a logical-architecture block diagram that illustrates a system including a evaluation engine and other components as described herein configured for determining a financial capacity of an international student, scholar, and/or other international individuals associated with an educational institution.

FIG. 2 illustrates an embodiment of a login view of a graphical user interface that may be presented to a user on a computing device associated with the user.

FIG. 3 illustrates a view of weights associated with algorithm inputs for an algorithm used to determine the financial capacity.

FIG. 4 is a diagram that illustrates an exemplary computing system in accordance with embodiments of the present system.

FIG. 5 is a flow chart that illustrates a process for determining a financial capacity of an international student, scholar, and/or other international individuals associated with an educational institution within embodiments of the present system.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of housing for international students, scholars, and/or others. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

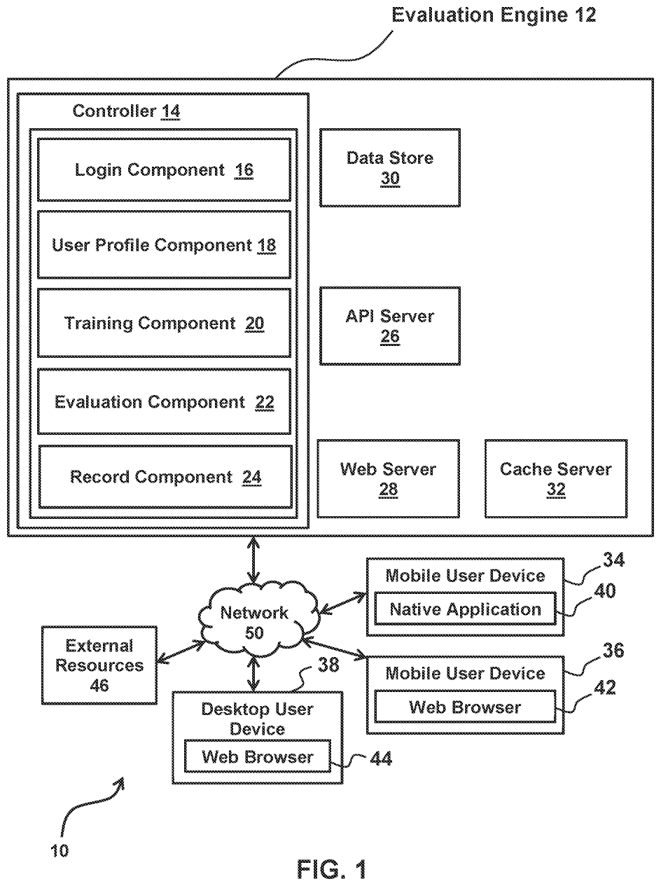

FIG. 1 illustrates a system 10 comprising an evaluation engine 12 and other components configured to determine a financial capacity of an international student, scholar, and/or other international individuals associated with educational institutions in the United States. System 10 is configured to help such people find housing in the U.S. using a novel algorithm. Most international students, scholars, and/or other international individuals move to the US from abroad. When they move, they do not typically have traditional credit, a social security number, and/or other U.S. requirements used by landlords, for example, to obtain housing.

Accordingly, there is an unmet need for a system that automatically determines whether an international student, scholar, and/or other individuals associated with an educational institution in the United States have the financial capacity to make regular rent and/or other financial payments. Further, existing computer systems by which landlords and/or others might use to determine the financial capacity of such individuals are not well suited for addressing this need, as such systems (e.g., foreign banking systems, U.S. government databases, etc.) that might be used to obtain financial information about these international individuals is disparate, and can be difficult for an average landlord to access, if such systems exist at all.

System 10 meets this unmet need. In some embodiments, system 10 is configured to automatically determine the financial capacity of an international student, scholar, and/or other international individuals associated with an educational institution. Such individuals are described as users in the following discussion. Advantageously, system 10 is configured such that a landlord (for example) utilizing system 10 may incur fewer overhead costs since it is cheaper to deal directly with users (e.g., international students) than through third parties (e.g., credit agencies, banks, U.S. government entities, etc.). System 10, in some embodiments, may attract a large network of users and/or landlords because it can track the payment performance of thousands or even millions of users over time and use that data to predict the financial capacity of current and future users more accurately, thereby being able to assist even more users (international students, scholars, etc.) to obtain housing.

System 10 utilizes available information and information obtained from users (e.g., international students, scholars, and/or other associated with educational institutions) to predict or otherwise determine an individual's financial capacity. For example, a Form I-20 includes quantitative data showing how much money an individual was required to have to enter the U.S. (e.g., the U.S. checks to ensure an individual has the necessary resources to live in the U.S.). As another example, system 10 also utilizes an individual's visa type to evaluate financial capacity. The visa type can indicate whether an individual is permitted to work in the U.S., an amount of time the individual is allowed to remain in the U.S., and/or other information. System 10 is configured to access and use this information to perform hundreds, thousands, or even millions of determinations for corresponding individuals, which cannot be done with existing systems.

A landlord, for example, may use system 10 to quickly and reliably determine whether an international student, scholar, and/or other individual associated with a university has the financial capacity to meet rent and/or other financial obligations while they are in the U.S. In addition, system 10 removes friction of communication between landlords and potential tenants (e.g. international students). The removal of this friction is based on the removal of a language barrier, which might have existed between an international, non-native English speaker, and a landlord who is a native English speaker (by replacing it with an export that is comprised of numbers on a scale that either party is likely to recognize and understand). This results in cost and time savings for both parties involved in the transaction. Further, this reduces the likelihood of a negative business outcome for either party for reasons other than a fair assessment of financial capacity. (i.e., landlord loses patience, student feels unwelcome, etc.)

These and other benefits are described in greater detail below, after introducing the components of system 10 and describing their operation. It should be noted, however, that not all embodiments necessarily provide all of the benefits outlined herein, and some embodiments may provide all or a subset of these benefits or different benefits, as various engineering and cost tradeoffs are envisioned, which is not to imply that other descriptions are limiting.

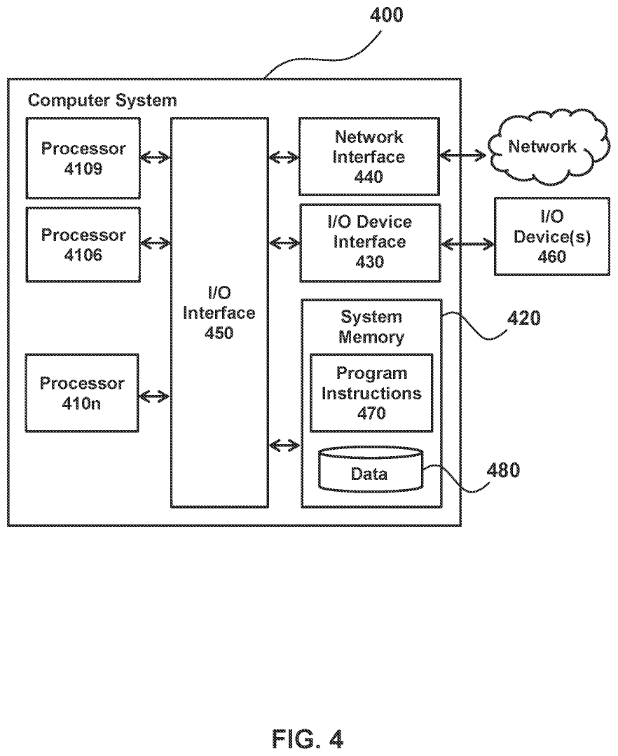

In some embodiments, evaluation engine 12 is executed by one or more of the computers described below with reference to FIG. 4 and includes an application program interface (API) server 26, a web server 28, a data store 30, and a cache server 32. These components, in some embodiments, communicate with one another in order to provide the functionality of evaluation engine 12 described herein. As described in greater detail below, in some embodiments, data store 30 may store data about users including user information, current rental transactions, rental transactions completed by users including prior payment history information, weights associated with different types of information, relational data, and/or other information. User information may include financial information about a user, visa information, student type information, visa information, employment information, scholarship information, sponsorship information, a university program period, and/or other information.

Cache server 32 may expedite access to this data by storing likely relevant data in relatively high-speed memory, for example, in random-access memory or a solid-state drive. Web server 28 may serve webpages having graphical user interfaces that display login views, advertisements, one or more views that facilitate housing transactions by users and/or landlords, one or more views that facilitate obtaining information from a user, or other displays. API server 26 may serve data to various applications that process data related to user logins, the advertisements, the housing transactions, or other data. The operation of these components 26, 28, and 30 may be coordinated by a controller 14, which may bidirectionally communicate with each of these components or direct the components to communicate with one another. Communication may occur by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

Among other operations, in some embodiments, evaluation engine 12 trains an algorithm using input output training pairs that describe prior financial information, prior visa information, prior student type information, and/or prior housing payment history information, for a population of international students and/or scholars affiliated with educational institutions in the United States. Evaluation engine 12 receives new financial information, new visa information, and/or new student type information for a new international student or scholar to the algorithm; and determines, with the algorithm, relational data indicative of the financial capacity for the new international student or scholar based on the new financial information, new visa information, and/or new student type information. Evaluation engine 12 also determines, with the algorithm, based on the relational data, the new financial information, the new visa information, the new student type information, and/or other information, the financial capacity of the international student or scholar to pay for housing in the United States while the international student or scholar is affiliated with an educational institution.

In some embodiments, interaction with users, landlords, and/or other entities may occur via a website or a native application viewed on a desktop computer, tablet, or a laptop of the user. In some embodiments, such interaction occurs via a mobile website viewed on a smart phone, tablet, or other mobile user device, or via a special-purpose native application executing on a smart phone, tablet, or other mobile user device. Facilitating financial capacity determinations across a variety of devices is expected to make it easier for the users and landlords to complete housing transactions when and where convenient for the user and/or the landlord.

To illustrate an example of the environment in which evaluation engine 12 operates, the illustrated embodiment of FIG. 1 includes a number of components with which evaluation engine 12 communicates: mobile user devices 34 and 36; a desk-top user device 38; and external resources 46. Each of these devices communicates with evaluation engine 12 via a network 50, such as the Internet or the Internet in combination with various other networks, like local area networks, cellular networks, Wi-Fi networks, or personal area networks.

Mobile user devices 34 and 36 may be smart phones, tablets, gaming devices, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), and a processor (a term which, as used herein, includes one or more processors) coupled to each of these components. The memory of mobile user devices 34 and 36 may store instructions that when executed by the associated processor provide an operating system and various applications, including a web browser 42 or a native mobile application 40. The desktop user device 38 may also include a web browser 44. In addition, desktop user device 38 may include a monitor; a keyboard; a mouse; memory; a processor; and a tangible, non-transitory, machine-readable memory storing instructions that when executed by the processor provide an operating system and the web browser. Native application 40 and web browsers 42 and 44, in some embodiments, are operative to provide a graphical user interface associated with a user and/or a landlord, for example, that communicates with evaluation engine 12 and facilitates user and/or landlord interaction with data from evaluation engine 12. Web browsers 42 and 44 may be configured to receive a website from evaluation engine 12 having data related to instructions (for example, instructions expressed in JavaScript™) that when executed by the browser (which is executed by the processor) cause mobile user device 36 and/or desktop user device 38 to communicate with evaluation engine 12 and facilitate user and/or landlord interaction with data from evaluation engine 12. Native application 40 and web browsers 42 and 44, upon rendering a webpage and/or a graphical user interface from evaluation engine 12, may generally be referred to as client applications of evaluation engine 12, which in some embodiments may be referred to as a server. Embodiments, however, are not limited to client/server architectures, and evaluation engine 12, as illustrated, may include a variety of components other than those functioning primarily as a server. Three user devices are shown, but embodiments are expected to interface with substantially more, with more than 100 concurrent sessions and serving more than 1 million users distributed over a relatively large geographic area, such as a state, the entire United States, and/or multiple countries across the world.

External resources 46, in some embodiments, include sources of information such as databases, websites, etc.; external entities participating with the system 10 (e.g., systems or networks associated with the U.S. government and applicable student visa programs), one or more servers outside of the system 10, a network (e.g., the internet), electronic storage, equipment related to Wi-Fi™ technology, equipment related to Bluetooth® technology, data entry devices, or other resources. In some implementations, some or all of the functionality attributed herein to external resources 46 may be provided by resources included in the system 10. External resources 46 may be configured to communicate with evaluation engine 12, mobile user devices 34 and 36, desktop user device 38, and/or other components of the system 10 via wired and/or wireless connections, via a network (e.g., a local area network and/or the internet), via cellular technology, via Wi-Fi technology, and/or via other resources.

Thus, evaluation engine 12, in some embodiments, operates in the illustrated environment by communicating with a number of different devices and transmitting instructions to various devices to communicate with one another. The number of illustrated external resources 46, desktop user devices 38, and mobile user devices 36 and 34 is selected for explanatory purposes only, and embodiments are not limited to the specific number of any such devices illustrated by FIG. 1, which is not to imply that other descriptions are limiting.

Evaluation engine 12 of some embodiments includes a number of components introduced above that facilitate determination of the financial capacity of a user. For example, the illustrated API server 26 may be configured to communicate data about users, housing transactions, and/or other information via a protocol, such as a representational-state-transfer (REST)-based API protocol over hypertext transfer protocol (HTTP) or other protocols. Examples of operations that may be facilitated by the API server 26 include requests to display, link, modify, add, or retrieve portions or all of user profiles, housing transactions, or other information. API requests may identify which data is to be displayed, linked, modified, added, or retrieved by specifying criteria for identifying records, such as queries for retrieving or processing information about a particular user (e.g., a user's visa information as described herein), for example. In some embodiments, the API server 26 communicates with the native application 40 of the mobile user device 34 or other components of system 10.

The illustrated web server 28 may be configured to display, link, modify, add, or retrieve portions or all of user profiles, housing transactions, or other information encoded in a webpage (e.g. a collection of resources to be rendered by the browser and associated plug-ins, including execution of scripts, such as JavaScript™, invoked by the webpage). In some embodiments, the graphical user interface presented by the webpage may include inputs by which the user may enter or select data, such as clickable or touchable display regions or display regions for text input. Such inputs may prompt the browser to request additional data from the web server 28 or transmit data to the web server 28, and the web server 28 may respond to such requests by obtaining the requested data and returning it to the user device or acting upon the transmitted data (e.g., storing posted data or executing posted commands). In some embodiments, the requests are for a new webpage or for data upon which client-side scripts will base changes in the webpage, such as XMLHttpRequest requests for data in a serialized format, e.g. JavaScript™ object notation (JSON) or extensible markup language (XML). The web server 28 may communicate with web browsers, such as the web browser 42 or 44 executed by user devices 36 or 38. In some embodiments, the webpage is modified by the web server 28 based on the type of user device, e.g., with a mobile webpage having fewer and smaller images and a narrower width being presented to the mobile user device 36, and a larger, more content rich webpage being presented to the desk-top user device 38. An identifier of the type of user device, either mobile or non-mobile, for example, may be encoded in the request for the webpage by the web browser (e.g., as a user agent type in an HTTP header associated with a GET request), and the web server 28 may select the appropriate interface based on this embedded identifier, thereby providing an interface appropriately configured for the specific user device in use.

The illustrated data store 30, in some embodiments, stores data about users and housing transactions associated with users. Data store 30 may include various types of data stores, including relational or non-relational databases, document collections, hierarchical key-value pairs, or memory images, for example. Such components may be formed in a single database, document, or the like, or may be stored in separate data structures. In some embodiments, data store 30 comprises electronic storage media that electronically stores information. The electronic storage media of data store 30 may include one or both of system storage that is provided integrally (i.e., substantially non-removable) with the system 10 and/or removable storage that is removably connectable to the system 10 via, for example, a port (e.g., a USB port, a firewire port, etc.) or a drive (e.g., a disk drive, etc.). Data store 30 may be (in whole or in part) a separate component within the system 10, or data store 30 may be provided (in whole or in part) integrally with one or more other components of the system 10 (e.g., controller 14, etc.). In some embodiments, data store 30 may be located in a data center, in a server that is part of external resources 46, in a computing device 34, 36, or 38, and/or in other locations. Data store 30 may include one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), or other electronically readable storage media. Data store 30 may store software algorithms, information determined by controller 14, information received via the graphical user interface displayed on computing devices 34, 36, and/or 38, information received from external resources 46, or other information accessed by system 10 to function as described herein.

Controller 14 is configured to coordinate the operation of the other components of evaluation engine 12 to provide the functionality described herein. Controller 14 may be formed by one or more processors, for example. Controlled components may include one or more of a login component 16, a user profile component 18, a training component 20, an evaluation component 22, a record component 24, and/or other components. Controller 14 may be configured to direct the operation of components 16, 18, 20, 22, and/or 24 by software; hardware; firmware; some combination of software, hardware, or firmware; or other mechanisms for configuring processing capabilities.

It should be appreciated that although components 16, 18, 20, 22, and 24 are illustrated in FIG. 1 as being co-located, one or more of components 16, 18, 20, 22, or 24 may be located remotely from the other components. The description of the functionality provided by the different components 16, 18, 20, 22, and/or 24 described below is for illustrative purposes, and is not intended to be limiting, as any of the components 16, 18, 20, 22, and/or 24 may provide more or less functionality than is described, which is not to imply that other descriptions are limiting. For example, one or more of components 16, 18, 20, 22, and/or 24 may be eliminated, and some or all of its functionality may be provided by others of the components 16, 18, 20, 22, or 24, again which is not to imply that other descriptions are limiting. As another example, controller 14 may be configured to control one or more additional components that may perform some or all of the functionality attributed below to one of the components 16, 18, 20, 22, and/or 24. In some embodiments, evaluation engine 12 (e.g., controller 14 in addition to cache server 32, web server 28, and/or API server 26) is executed in a single computing device, or in a plurality of computing devices in a datacenter, e.g., in a service oriented or micro-services architecture.

Login component 16, in some embodiments, is configured to cause presentation (e.g., via API server 26 and/or web server 28 by sending instructions to a user device) of a login view of a graphical user interface to a user (e.g., via mobile user devices 34 or 36, or desktop user device 38). Login component 16, in some embodiments, is configured to receive login information for a user. As noted above, mobile user devices 34 or 36, or desktop user device 38 may be associated with a user in memory of evaluation engine 12. The graphical user interface, in some embodiments, may be associated with the user, a landlord, and/or other entities. In some embodiments, the graphical user interface is a website or a native application with compiled application code stored in memory of the user devices. The login information may be entered (e.g., which includes entry or selection) by the user via the login view. Entry by the user includes accessing resources (like requesting content from a URL) that cause the login information to be retrieved from memory of the user device (e.g., by causing a script to be downloaded that accesses login credentials from client-side persistent storage, like a cookie or a localStorage object in a browser, or from a third party, e.g., an OAuth service). The login information may identify the user (which includes anonymized identifiers sufficient to distinguish one user from another, without personally identifying the user). In some embodiments, the login information includes an identifying user name or number, a password, an email address, or other information.

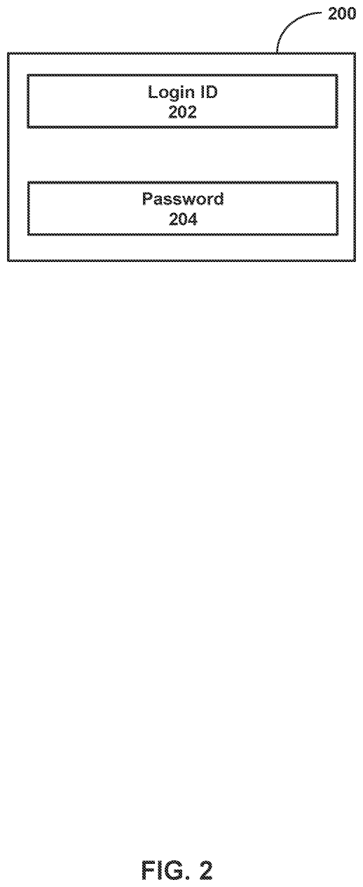

FIG. 2 illustrates an embodiment of a login view 200 of a graphical user interface that may be presented to a user on the mobile user devices 34 or 36, the desktop user device 38, or other devices. In this example, the view 200 includes a login identification field 202 and a password field 204 (other fields are contemplated). The login information may be entered or selected by a user via fields 202 and/or 204 via a touchscreen (e.g., such that a user touches field 202 and/or 204 and then enters and/or selects information via fields 202 or 204, or a follow up field or view that appears as a result of the touch), a keyboard, a mouse, or entry or selection components that are part of the mobile user devices 34 or 36, the desktop user device 38, or other devices.

Returning to FIG. 1, user profile component 18 is configured to link the login information to previously stored (e.g., in data store 30 and/or external resources 46) user profile information for the user. In some embodiments, user profile component 18 is configured to cause presentation (e.g., via API server 26 or web server 28) of one or more views of the graphical user interface that facilitate entry (which includes selection as described herein) of user profile information by the user. In some embodiments, the user profile information indicates one or more of user identification information (e.g., name, login user name or number, a password, an email address, etc.), financial information including types of financial accounts held by the user and/or a dollar value of assets in the accounts, payment history information, visa information, student type information, an age of the user, a geographical location of the user, a login frequency of the user, time since a most recent login by the user, area code of the user's telephone number, e-mail address of the user, or other information. In some embodiments, the financial information comprises information from a Form I-20, a bank balance, scholarship information, sponsorship information, employment information, types of assets owned by the international student or scholar, financial history information (e.g., debts incurred and/or payments made), and/or other information for the international student or scholar (e.g., the user). In some embodiments, the visa information comprises a visa type, a visa validity period, a university program period for the international student or scholar, and/or other information. In some embodiments, the student type information comprises an indication of whether the international student or scholar is an undergraduate or graduate student, and/or an indication of whether the international student or scholar is new versus transferring or continuing.

In some embodiments, some or all of the above described information may be automatically obtained by user profile component 18 from one or more electronically accessible databases. These databases may be provided within and/or outside of system 10 (e.g., by data store 30 and/or external resources 46). The information may be automatically obtained based on a user's name, email address, identifying number, and/or other unique identifiers. As one possible example, a user may have a unique service identification number associated with a visa, an educational institution, and/or other entities. A SEVIS (Student and Exchange Visitor System) ID is issued/created by the Department of Homeland Security (DHS) and is part of the Student and Exchange Visitor Program (SEVP) (see https://studyinthestates.dhs.gov/site/about-sevis). A service (SEVIS) identification number is a unique number identifier that can be used for identification purposes (e.g., it may be thought of as similar to a social security number). Individualized information about a user is stored on service databases which universities and/or other entities that are part of a service program traditionally have access to.

Training component 20 is configure to train an algorithm using input output training pairs and/or other data that describe prior financial information, prior visa information, prior student type information, and/or prior housing payment history information, for a population of international students and/or scholars affiliated with educational institutions in the United States. In some embodiments, training component 20 is configured to cause the algorithm to learn to predict a user's financial capacity and/or likelihood to regularly make housing related payments based on the prior financial information, prior visa information, prior student type information, and/or prior housing payment history information, for the population of international students and/or scholars affiliated with educational institutions in the United States. In some embodiments, this includes determining which algorithm inputs are predictive of financial capacity, determining how to combine (mathematically or otherwise) such inputs to optimize the predictive power of the algorithm, assigning a weight or percentage to different algorithm inputs, and/or other operations. For example, the training may cause the financial information about a user to be weighted heaviest, with visa information weighted second heaviest, and student type information weighted third heaviest by the algorithm for the determination of the financial capacity. In some embodiments, future predictions of financial capacity for pluralities of different potential users may be determined based on the trained algorithm (e.g., as described below).

In some embodiments, the algorithm is configured (e.g., programmed) manually by a human trainer. This configuration may be based on one or more of personal experience with the process of obtaining the documents/data sets and having gone through visa interviews that state the relative importance of various factors, research on legacy credit scoring systems and student visa/immigration policies to determine relevant factors that have correlations, student interviews for different Visa types that provided understanding of the different requirements for the various programs and how well funded the student was along with what their flexibility with earning income was, and/or tracking of user payment behavior and contrasting that behavior with initial system 10 predictions.

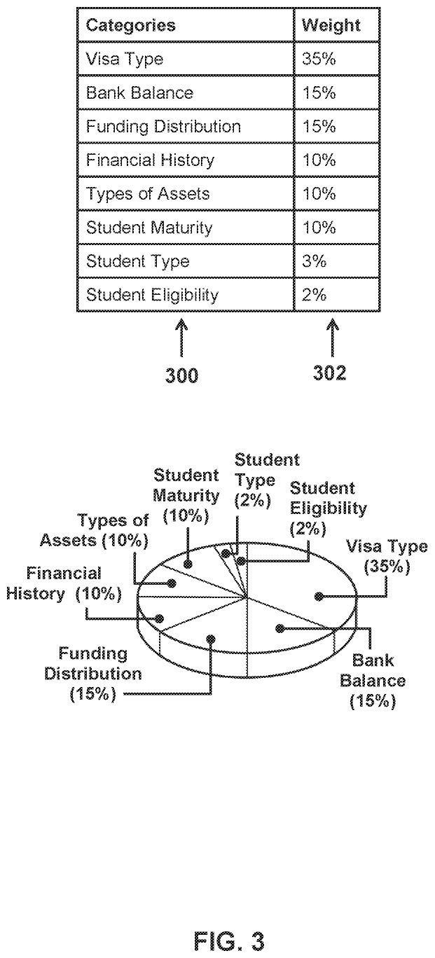

FIG. 3 illustrates a view of example weights 302 (shown as percentages) associated with algorithm inputs 300 for an algorithm used to determine the financial capacity of a user. FIG. 3 shows one possible example of many for a set of algorithm inputs 300, and weights 302 associated with those algorithm inputs. Example algorithm inputs may include visa type (weighted at 35% in this example); a bank balance (weighted at 15%); funding distribution indicating whether the international student or scholar is self-funded, funded by a family member, funded by a scholarship, etc. (weighted at 15%); financial history indicating prior debts incurred and/or payments made (weighted at 10%); types of assets owned by the international student or scholar such as real estate, bank accounts, stocks, etc. (weighted at 10%); maturity or age (weighted at 10%); student type such as undergraduate or graduate (weighted at 3%); and eligibility indicating whether a visa expiration date is after an expected university program period (weighted at 2%).

Returning to FIG. 1, in some embodiments, the algorithm may comprise one or more individual algorithms. In some embodiments, an algorithm may be a machine learning algorithm. In some embodiments, the machine learning algorithm may be or include a neural network, classification tree, decision tree, support vector machine, or other model that is trained (e.g., with a stochastic gradient descent) and configured to determine the financial capacity of a user. As an example, neural networks may be based on a large collection of neural units (or artificial neurons). Neural networks may loosely mimic the manner in which a biological brain works (e.g., via large clusters of biological neurons connected by axons). Each neural unit of a neural network may be simulated as being connected with many other neural units of the neural network. Such connections can be enforcing or inhibitory in their effect on the activation state of connected neural units. In some embodiments, each individual neural unit may have a summation function which combines the values of all its inputs together. In some embodiments, each connection (or the neural unit itself) may have a threshold function such that the signal must surpass the threshold before it is allowed to propagate to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for neural networks may be more free-flowing, with connections interacting in a more chaotic and complex fashion.

Evaluation component 22 is configured to input new financial information, new visa information, new student type information, and/or other information for a new international student or scholar to the algorithm. Evaluation component 22 is configured to determine, with the algorithm, relational data indicative of the financial capacity for the international student or scholar based on the new financial information, new visa information, new student type information, and/or other information. The relational data comprises an indication of whether the international student or scholar is permitted to work, whether a visa validity period is longer than a university program period, whether the international student or scholar has excess funding compared to that required for attending university in the United States, and/or other information.

In some embodiments a framework that establishes a liquidity scale that the different sources of funding would fall on may be used—i.e., demonstrated sufficient balance on a bank account owned by the user would be more liquid than a sponsorship letter from a parent/friend because the user has less direct access/control of those funds. This is combined with the “level” of funding provides even more precision—e.g., a user who has 30% of the necessary funds in their own account (highly liquid) and the rest, 70%, in scholarship (lower liquidity due to conditions) would rank lower than someone who has it the other way around (70%) liquid. But Both would rank lower than someone who has 100% (or more in cash).

Evaluation component 22 is configured to determine, with the algorithm, based on the relational data, the new financial information, the new visa information, and/or the new student type information, the financial capacity of the international student or scholar to pay for housing in the United States while the international student or scholar is affiliated with an educational institution.

As an example, possible inputs to the algorithm may be the period that a visa obtained by an international student is valid, and the duration of a university program (a university program period) the student plans to attend. In this example, if a student applies to a two year program receives a two year visa, the algorithm is trained and/or otherwise configured to recognize that positive correlation, which enhances the student's capacity to pay for housing in the U.S. Conversely, if the student is attending a two year program, but only receives a one year visa, the algorithm is trained and/or otherwise configured to recognize the scrutiny, or possibly doubts the U.S. government may have about the validity of the student's reasons for being in the U.S., or a student's financial capacity to be able to live in the U.S. In this situation, during the university program, if the student wants to visit home between years of the university program (e.g., over a summer), they will have to obtain another visa upon their return to the U.S. This contrasts with the student who has a visa that is the length of their program. Further, the algorithm is also trained and/or otherwise configured to recognize when a student has a visa that is valid longer than the university program period.

As another example, possible inputs to the algorithm may include the type of visa a student has. Some visas permit the student, scholar, and/or other international individual to work while in the U.S., while others do not. The algorithm is configured to rank different visas highest to lowest based on a student's, scholar's, and/or other international individual's earning potential while on a specific visa. In this example, on an F1 visa a student can work on, or off-campus (more earnings and flexibility) while in school, whereas on a J1 visa students can only work part time on campus. M1 visa students are not allowed to work at all. F1 visa students also have access to something called the OPT program and the STEM-OPT extension they can use to work full time and earn market rate wages, further increasing their opportunity to be solvent.

In some embodiments, visa related inputs (e.g., as described above) are weighted just behind financial related inputs (e.g., as described below) for the determination of whether a student, scholar, and/or other international individual has the financial capacity to pay for housing in the U.S. This is because the visa related inputs represent a forecast/forward outlook, whereas financial inputs are often related to a user's current finances.

As a further example, possible inputs to the algorithm may include data from a student's form I-20, alongside data from bank statements the student may provide (or system 10 may automatically obtain). A international student who receives an I-20 will have at least 100% of the funds required by the U.S. government to enter the U.S. The algorithm is configured to determine how much more money than the minimum required funding the student has in the student's current possession to determine financial health. In addition, the algorithm is configured to recognize how the funds are distributed. For this example, consider four general categories: (1) personal funds, (2) scholarships, (3) sponsorships by friends, relatives, or a private company, and (4) on-campus employment. The algorithm may be configured to rank each of these based on how much access the student has to the source of funds, with personal funds being the most accessible. The algorithm may also be configured to determine how much of each type of funding the students has, which creates an evaluation mix (e.g., which may be weighted as described herein) for this section. The algorithm is configured to assess bank statements by, among other possible operations, determining whether the bank balance covers the I-20 expenses alone, and if so how long it has displayed that balance (e.g., 30 days, 60 days, 90 days, . . . up to some maximum amount of days); determining who actually owns the bank account (e.g., a student or a sponsor); etc.

As a still further example, possible inputs to the algorithm may include student type and/or status information. In some embodiments, graduate (older & more mature) students are better payers than undergraduate students, which the algorithm is configured to recognize and incorporate into a financial capacity determination. Incoming international students are more liquid than returning/transfer students who have gone through part of their program and have spent funds from their initial budget. New students are more solvent, which the algorithm is configured to recognize and incorporate into a financial capacity determination.

Other examples are contemplated. For example, in some embodiments, possible inputs to the algorithm may include information such as test scores, countries of origin, and other demographic data which impact the financial capacity of an international student, scholar, and/or other individual.

In some embodiments, determining the financial capacity of the international student or scholar to pay for housing in the United States while the international student or scholar is affiliated with the educational institution comprises determining a score. The score may be binary (e.g., yes financially capable, or no, not financially capable. The score may be on a scale that is similar to a legacy credit scoring scale such as a scale used by Fico, Experian, TransUnion, etc. The score may also take other forms.

Record component 24 is configured to create a record of the prediction of the financial capacity of a user, later housing related payments made by the user (including whether the payments were made on time and in the correct amount), and/or other information. In some embodiments, the record is stored in data store 30 or other storage locations. In some embodiments, the record is incorporated into the user profile information for the user.

In some embodiments, record component 24 is configured to receive, and provide to the algorithm, later payment information for the international student or scholar indicating whether payments for the housing in the United States while the international student or scholar is affiliated with the educational institution have been made. Record component 24 is configured to iteratively update, based on the later payment information, the training of the algorithm, such that the determining of the financial capacity of the international student or scholar to pay for housing in the United States while the international student or scholar is affiliated with the educational institution is automatically personalized for the international student or scholar over time.

With the iterative updating, the algorithm (e.g., a machine learning model) may suffer from false positives or false negatives during self-training—e.g., it may increase the importance of a wrong factor in the algorithm if too many users experience it at once; it may be an outlier case. To avoid this, the algorithm may be configured to run four simultaneous instances of the algorithm (though only one may be presented to the user). There may be a “base case” model, for example, which is the core of a score and a direct result of human training and have equally weighted positive and negative effects to the score/model. There may be an “upper case” and a “lower Case” model that have different levels of impact on a score where a fault is determined. “Upper case” may have more impactful positive adjustments and less impactful negative adjustments to a score whereas “lower case” may have the reverse. The fourth instance may be an “initial case” which is a version of a score that may run the algorithm as if it never trained itself.

It should be noted that in some embodiments, evaluation engine 12 may be configured such that in the above mentioned operations of the controller 14, input from users and/or sources of information inside or outside system 10 may be processed by controller 14 through a variety of formats, including clicks, touches, uploads, downloads, etc. The illustrated components (e.g., controller 14, API server 26, web server 28, data store 30, and cache server 32) of evaluation engine 12 are depicted as discrete functional blocks, but embodiments are not limited to systems in which the functionality described herein is organized as illustrated by FIG. 1. The functionality provided by each of the components of evaluation engine 12 may be provided by software or hardware modules that are differently organized than is presently depicted, for example such software or hardware may be intermingled, broken up, distributed (e.g. within a data center or geographically), or otherwise differently organized. The functionality described herein may be provided by one or more processors of one or more computers executing code stored on a tangible, non-transitory, machine readable medium.

FIG. 4 is a diagram that illustrates an exemplary computer system 400 in accordance with embodiments of the present system. Various portions of systems and methods described herein, may include or be executed on one or more computer systems the same as or similar to computer system 400. For example, evaluation engine 12, mobile user device 34, mobile user device 36, desktop user device 38, external resources 46 and/or other components of the system 10 (FIG. 1) may be and/or include one more computer systems the same as or similar to computer system 400. Further, processes, modules, processor components, and/or other components of system 10 described herein may be executed by one or more processing systems similar to and/or the same as that of computer system 400.

Computer system 400 may include one or more processors (e.g., processors 410a-410n) coupled to system memory 420, an input/output I/O device interface 430, and a network interface 440 via an input/output (I/O) interface 450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computer system 400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 420). Computer system 400 may be a uni-processor system including one processor (e.g., processor 410a), or a multi-processor system including any number of suitable processors (e.g., 410a-410n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computer system 400 may include a plurality of computing devices (e.g., distributed computer systems) to implement various processing functions.

I/O device interface 430 may provide an interface for connection of one or more I/O devices 460 to computer system 400. I/O devices may include devices that receive input (e.g., from a user) or output information (e.g., to a user). I/O devices 460 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 460 may be connected to computer system 400 through a wired or wireless connection. I/O devices 460 may be connected to computer system 400 from a remote location. I/O devices 460 located on a remote computer system, for example, may be connected to computer system 400 via a network and network interface 440.

Network interface 440 may include a network adapter that provides for connection of computer system 400 to a network. Network interface may 440 may facilitate data exchange between computer system 400 and other devices connected to the network. Network interface 440 may support wired or wireless communication. The network may include an electronic communication network, such as the Internet, a local area network (LAN), a wide area network (WAN), a cellular communications network, or the like.

System memory 420 may be configured to store program instructions 470 or data 480. Program instructions 470 may be executable by a processor (e.g., one or more of processors 410a-410n) to implement one or more embodiments of the present techniques. Instructions 470 may include modules and/or components (e.g., components 16-24 shown in FIG. 1) of computer program instructions for implementing one or more techniques described herein with regard to various processing modules and/or components. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 420 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 420 may include a non-transitory computer readable storage medium that may have program instructions stored thereon that are executable by a computer processor (e.g., one or more of processors 410a-410n) to cause the subject matter and the functional operations described herein. A memory (e.g., system memory 420) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 450 may be configured to coordinate I/O traffic between processors 410a-410n, system memory 420, network interface 440, I/O devices 460, and/or other peripheral devices. I/O interface 450 may perform protocol, timing, or other data transformations to convert data signals from one component (e.g., system memory 420) into a format suitable for use by another component (e.g., processors 410a-410n). I/O interface 450 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 400 or multiple computer systems 400 configured to host different portions or instances of embodiments. Multiple computer systems 400 may provide for parallel or sequential processing/execution of one or more portions of the techniques described herein.

Those skilled in the art will appreciate that computer system 400 is merely illustrative and is not intended to limit the scope of the techniques described herein. Computer system 400 may include any combination of devices or software that may perform or otherwise provide for the performance of the techniques described herein. For example, computer system 400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a television or device connected to a television (e.g., Apple TV™), or a Global Positioning System (GPS), or the like. Computer system 400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

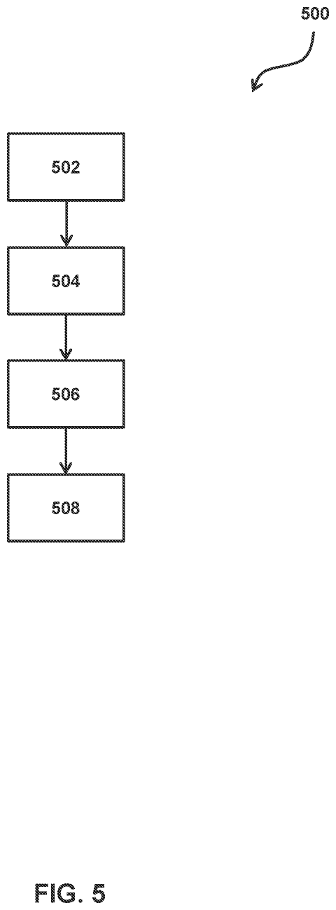

FIG. 5 is a flowchart of a method 500 for determining a financial capacity of an international student or scholar within some embodiments of system 10 (FIG. 1) discussed above. In the embodiment associated with FIG. 5, method 500 begins with training an algorithm using input output training pairs that describe prior financial information, prior visa information, prior student type information, and/or prior housing payment history information, for a population of international students and/or scholars affiliated with educational institutions in the United States, as illustrated by block 502. This step may be performed by the above-mentioned training component 20 and/or other components of system 10. In some embodiments, the algorithm comprises a machine learning algorithm. In some embodiments, the machine learning algorithm comprises a neural network.

New financial information, new visa information, and/or new student type information for the international student or scholar is inputted to the algorithm, as indicated by block 504. This step may be performed by the above-mentioned evaluation component 22 and/or other components of system 10. The new financial information is weighted heaviest, the new visa information is weighted second heaviest, and the new student type information is weighted third heaviest by the algorithm for the determination of the financial capacity. The new financial information comprises information from a Form I-20, a bank balance, scholarship information, sponsorship information, employment information, and/or other information for the international student or scholar. The new visa information comprises a visa type, a visa validity period, a university program period, and/or other information for the international student or scholar. The new student type information comprises an indication of whether the international student or scholar is an undergraduate or graduate student, an indication of whether the international student or scholar is new versus transferring or continuing, and/or other information.

Method 500 includes (1) determining, with the algorithm, relational data indicative of the financial capacity for the international student or scholar based on the new financial information, new visa information, and/or new student type information; and (2) determining, with the algorithm, based on the relational data, the new financial information, the new visa information, and/or the new student type information, the financial capacity of the international student or scholar to pay for housing in the United States while the international student or scholar is affiliated with an educational institution, as indicated by block 506. This step may be performed by the above-mentioned evaluation component 22 and/or other components of system 10.

In some embodiments, the relational data comprises an indication of whether the international student or scholar is permitted to work, whether a visa validity period is longer than a university program period, whether the international student or scholar has excess funding compared to that required for attending university in the United States, and/or other information.

In some embodiments, determining the financial capacity of the international student or scholar to pay for housing in the United States while the international student or scholar is affiliated with the educational institution comprises determining a score.

In some embodiments, method 500 includes receiving, with the algorithm, later payment information for the international student or scholar indicating whether payments for the housing in the United States while the international student or scholar is affiliated with the educational institution have been made; and iteratively updating, based on the later payment information, the training of the algorithm, such that the determining of the financial capacity of the international student or scholar to pay for housing in the United States while the international student or scholar is affiliated with the educational institution is automatically personalized for the international student or scholar over time, as indicated by block 508.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:
1. A method for automatically determining a financial capacity of an international university student who is attending an educational institution in the United States and has little or no domestic credit history, in order to assist the international university student in securing housing with landlords who would otherwise have limited resources for determining the financial capacity of the international university student, the automatically determining performed by a trained electronic financial capacity machine learning algorithm, the financial capacity machine learning algorithm executed by one or more processors of a computing device, the method comprising: training the financial capacity machine learning algorithm using input output training pairs that describe prior financial information, prior visa information, prior student type information, and prior housing payment history information, for a population of international university students attending university in the United States; accessing and inputting new financial information, new visa information, and/or new student type information for the international university student to the financial capacity machine learning algorithm; determining, with the financial capacity machine learning algorithm, relational data indicative of the financial capacity for the international university student based on the new financial information, new visa information, and/or new student type information; determining, with the financial capacity machine learning algorithm, based on the relational data, the new financial information, the new visa information, and/or the new student type information, the financial capacity of the international university student to pay for housing in the United States while attending university and/or maintaining student status; receiving, with the financial capacity machine learning algorithm, later payment information for the international university student indicating whether payments for the housing in the United States while attending university have been made; and iteratively updating, based on the later payment information, the training of the financial capacity machine learning algorithm, such that the determining of the financial capacity of the international university student to pay for housing in the United States while attending university is automatically personalized for the international university student over time.
2. The method of embodiment 1, wherein determining the financial capacity of the international university student to pay for housing in the United States while attending university comprises determining a score.
3. The method of any of the previous embodiments, wherein the new financial information is weighted heaviest, the new visa information is weighted second heaviest, and the new student type information is weighted third heaviest by the financial capacity machine learning algorithm for the determination of the financial capacity.
4. The method of any of the previous embodiments, wherein: the new financial information comprises information from a Form I-20, a bank balance, scholarship information, sponsorship information, and/or employment information for the international university student; the new visa information comprises a visa type, a visa validity period, and/or a university program period for the international university student; the new student type information comprises an indication of whether the international university student is an undergraduate or graduate student, and/or an indication of whether the international university student is new versus transferring or continuing; and the relational data comprises an indication of whether the international university student is permitted to work, whether the visa validity period is longer than the university program period, and/or whether the international university student has excess funding compared to that required for attending university in the United States.
5. The method of any of the previous embodiments, wherein the financial capacity machine learning algorithm comprises a neural network.
6. A method for determining a financial capacity of an international student or scholar, the method comprising: training an algorithm using input output training pairs that describe prior financial information, prior visa information, prior student type information, and/or prior housing payment history information, for a population of international students and/or scholars affiliated with educational institutions in the United States; inputting new financial information, new visa information, and/or new student type information for the international student or scholar to the algorithm; determining, with the algorithm, relational data indicative of the financial capacity for the international student or scholar based on the new financial information, new visa information, and/or new student type information; and determining, with the algorithm, based on the relational data, the new financial information, the new visa information, and/or the new student type information, the financial capacity of the international student or scholar to pay for housing in the United States while the international student or scholar is affiliated with an educational institution.
7. The method of any of the previous embodiments, further comprising receiving, with the algorithm, later payment information for the international student or scholar indicating whether payments for the housing in the United States while the international student or scholar is affiliated with the educational institution have been made; and iteratively updating, based on the later payment information, the training of the algorithm, such that the determining of the financial capacity of the international student or scholar to pay for housing in the United States while the international student or scholar is affiliated with the educational institution is automatically personalized for the international student or scholar over time.
8. The method of any of the previous embodiments, wherein determining the financial capacity of the international student or scholar to pay for housing in the United States while the international student or scholar is affiliated with the educational institution comprises determining a score.
9. The method of any of the previous embodiments, wherein the new financial information is weighted heaviest, the new visa information is weighted second heaviest, and the new student type information is weighted third heaviest by the algorithm for the determination of the financial capacity.
10. The method of any of the previous embodiments, wherein the new financial information comprises information from a Form I-20, a bank balance, scholarship information, sponsorship information, and/or employment information for the international student or scholar.
11. The method of any of the previous embodiments, wherein the new visa information comprises a visa type, a visa validity period, and/or a university program period for the international student or scholar.
12. The method of any of the previous embodiments, wherein the new student type information comprises an indication of whether the international student or scholar is an undergraduate or graduate student, and/or an indication of whether the international student or scholar is new versus transferring or continuing.
13. The method of any of the previous embodiments, wherein the relational data comprises an indication of whether the international student or scholar is permitted to work, whether a visa validity period is longer than a university program period, and/or whether the international student or scholar has excess funding compared to that required for attending university in the United States.
14. The method of any of the previous embodiments, wherein the algorithm comprises a machine learning algorithm.
15. The method of any of the previous embodiments, wherein the machine learning algorithm comprises a neural network.
16. A tangible, non-transitory, machine-readable medium storing instructions that when executed effectuate operations including: training an algorithm using input output training pairs that describe prior financial information, prior visa information, prior student type information, and/or prior housing payment history information, for a population of international students and/or scholars affiliated with educational institutions in the United States; inputting new financial information, new visa information, and/or new student type information for an international student or scholar to the algorithm; determining, with the algorithm, relational data indicative of a financial capacity for the international student or scholar based on the new financial information, new visa information, and/or new student type information; and determining, with the algorithm, based on the relational data, the new financial information, the new visa information, and/or the new student type information, the financial capacity of the international student or scholar to pay for housing in the United States while the international student or scholar is affiliated with an educational institution.
17. The medium of any of the previous embodiments, the operations further comprising receiving, with the algorithm, later payment information for the international student or scholar indicating whether payments for the housing in the United States while the international student or scholar is affiliated with the educational institution have been made; and iteratively updating, based on the later payment information, the training of the algorithm, such that the determining of the financial capacity of the international student or scholar to pay for housing in the United States while the international student or scholar is affiliated with the educational institution is automatically personalized for the international student or scholar over time.
18. The medium of any of the previous embodiments, wherein determining the financial capacity of the international student or scholar to pay for housing in the United States while the international student or scholar is affiliated with the educational institution comprises determining a score.
19. The medium of any of the previous embodiments, wherein the new financial information is weighted heaviest, the new visa information is weighted second heaviest, and the new student type information is weighted third heaviest by the algorithm for the determination of the financial capacity.
20. The medium of any of the previous embodiments, wherein the new financial information comprises information from a Form I-20, a bank balance, scholarship information, sponsorship information, and/or employment information for the international student or scholar.
21. The medium of any of the previous embodiments, wherein the new visa information comprises a visa type, a visa validity period, and/or a university program period for the international student or scholar.
22. The medium of any of the previous embodiments, wherein the new student type information comprises an indication of whether the international student or scholar is an undergraduate or graduate student, and/or an indication of whether the international student or scholar is new versus transferring or continuing.
23. The medium of any of the previous embodiments, wherein the relational data comprises an indication of whether the international student or scholar is permitted to work, whether a visa validity period is longer than a university program period, and/or whether the international student or scholar has excess funding compared to that required for attending university in the United States.
24. The medium of any of the previous embodiments, wherein the algorithm comprises a machine learning algorithm.
25. The medium of any of the previous embodiments, wherein the machine learning algorithm comprises a neural network.
26. A system for determining a financial capacity of an international university student, the system comprising one or more computers having one or more processors configured to effectuate operations comprising: training an algorithm using input output training pairs that describe prior financial information, prior visa information, prior student type information, and/or prior housing payment history information, for a population of international students and/or scholars affiliated with educational institutions in the United States; inputting new financial information, new visa information, and/or new student type information for the international student or scholar to the algorithm; determining, with the algorithm, relational data indicative of the financial capacity for the international student or scholar based on the new financial information, new visa information, and/or new student type information; and determining, with the algorithm, based on the relational data, the new financial information, the new visa information, and/or the new student type information, the financial capacity of the international student or scholar to pay for housing in the United States while the international student or scholar is affiliated with an educational institution.
27. The system of any of the previous embodiments, the operations further comprising receiving, with the algorithm, later payment information for the international student or scholar indicating whether payments for the housing in the United States while the international student or scholar is affiliated with the educational institution have been made; and iteratively updating, based on the later payment information, the training of the algorithm, such that the determining of the financial capacity of the international student or scholar to pay for housing in the United States while the international student or scholar is affiliated with the educational institution is automatically personalized for the international student or scholar over time.
28. The system of any of the previous embodiments, wherein determining the financial capacity of the international student or scholar to pay for housing in the United States while the international student or scholar is affiliated with the educational institution comprises determining a score.
29. The system of any of the previous embodiments, wherein the new financial information is weighted heaviest, the new visa information is weighted second heaviest, and the new student type information is weighted third heaviest by the algorithm for the determination of the financial capacity.
30. The system of any of the previous embodiments, wherein the new financial information comprises information from a Form I-20, a bank balance, scholarship information, sponsorship information, and/or employment information for the international student or scholar.
31. The system of any of the previous embodiments, wherein the new visa information comprises a visa type, a visa validity period, and/or a university program period for the international student or scholar.
32. The system of any of the previous embodiments, wherein the new student type information comprises an indication of whether the international student or scholar is an undergraduate or graduate student, and/or an indication of whether the international student or scholar is new versus transferring or continuing.
33. The system of any of the previous embodiments, wherein the relational data comprises an indication of whether the international student or scholar is permitted to work, whether a visa validity period is longer than a university program period, and/or whether the international student or scholar has excess funding compared to that required for attending university in the United States.
34. The system of any of the previous embodiments, wherein the algorithm comprises a machine learning algorithm.
35. The system of any of the previous embodiments, wherein the machine learning algorithm comprises a neural network.

What is claimed is:

1. A method for automatically determining a financial capacity of an international university student who is attending an educational institution in the United States and has little or no domestic credit history, in order to assist the international university student in securing housing with landlords who would otherwise have limited resources for determining the financial capacity of the international university student, the automatically determining performed by a trained electronic financial capacity machine learning algorithm, the financial capacity machine learning algorithm executed by one or more processors of a computing device, the method comprising:
training the financial capacity machine learning algorithm using input output training pairs that describe prior financial information, prior visa information, prior student type information, and prior housing payment history information, for a population of international university students attending university in the United States;
accessing and inputting new financial information, new visa information, and/or new student type information for the international university student to the financial capacity machine learning algorithm;
determining, with the financial capacity machine learning algorithm, relational data indicative of the financial capacity for the international university student based on the new financial information, new visa information, and/or new student type information;
determining, with the financial capacity machine learning algorithm, based on the relational data, the new financial information, the new visa information, and/or the new student type information, the financial capacity of the international university student to pay for housing in the United States while attending university and/or maintaining student status;
receiving, with the financial capacity machine learning algorithm, later payment information for the international university student indicating whether payments for the housing in the United States while attending university have been made; and
iteratively updating, based on the later payment information, the training of the financial capacity machine learning algorithm, such that the determining of the financial capacity of the international university student to pay for housing in the United States while attending university is automatically personalized for the international university student over time.

2. The method of claim 1, wherein determining the financial capacity of the international university student to pay for housing in the United States while attending university comprises determining a score.

3. The method of claim 1, wherein the new financial information is weighted heaviest, the new visa information is weighted second heaviest, and the new student type information is weighted third heaviest by the financial capacity machine learning algorithm for the determination of the financial capacity.

4. The method of claim 1, wherein:
the new financial information comprises information from a Form I-20, a bank balance, scholarship information, sponsorship information, and/or employment information for the international university student;
the new visa information comprises a visa type, a visa validity period, and/or a university program period for the international university student;
the new student type information comprises an indication of whether the international university student is an undergraduate or graduate student, and/or an indication of whether the international university student is new versus transferring or continuing; and
the relational data comprises an indication of whether the international university student is permitted to work, whether the visa validity period is longer than the university program period, and/or whether the international university student has excess funding compared to that required for attending university in the United States.

5. The method of claim 1, wherein the financial capacity machine learning algorithm comprises a neural network.

6. A method for determining a financial capacity of an international student or scholar, the method comprising:
training an algorithm using input output training pairs that describe prior financial information, prior visa information, prior student type information, and/or prior housing payment history information, for a population of international students and/or scholars affiliated with educational institutions in the United States;
inputting new financial information, new visa information, and/or new student type information for the international student or scholar to the algorithm;
determining, with the algorithm, relational data indicative of the financial capacity for the international student or scholar based on the new financial information, new visa information, and/or new student type information; and
determining, with the algorithm, based on the relational data, the new financial information, the new visa information, and/or the new student type information, the financial capacity of the international student or scholar to pay for housing in the United States while the international student or scholar is affiliated with an educational institution.

7. The method of claim 6, further comprising receiving, with the algorithm, later payment information for the international student or scholar indicating whether payments for the housing in the United States while the international student or scholar is affiliated with the educational institution have been made; and
iteratively updating, based on the later payment information, the training of the algorithm, such that the determining of the financial capacity of the international student or scholar to pay for housing in the United States while the international student or scholar is affiliated with the educational institution is automatically personalized for the international student or scholar over time.

8. The method of claim 6, wherein determining the financial capacity of the international student or scholar to pay for housing in the United States while the international student or scholar is affiliated with the educational institution comprises determining a score.

9. The method of claim 6, wherein the new financial information is weighted heaviest, the new visa information is weighted second heaviest, and the new student type information is weighted third heaviest by the algorithm for the determination of the financial capacity.

10. The method of claim 6, wherein the new financial information comprises information from a Form I-20, a bank balance, scholarship information, sponsorship information, and/or employment information for the international student or scholar.

11. The method of claim 6, wherein the new visa information comprises a visa type, a visa validity period, and/or a university program period for the international student or scholar.

12. The method of claim 6, wherein the new student type information comprises an indication of whether the international student or scholar is an undergraduate or graduate student, and/or an indication of whether the international student or scholar is new versus transferring or continuing.

13. The method of claim 6, wherein the relational data comprises an indication of whether the international student or scholar is permitted to work, whether a visa validity period is longer than a university program period, and/or whether the international student or scholar has excess funding compared to that required for attending university in the United States.

14. The method of claim 6, wherein the algorithm comprises a machine learning algorithm.

15. The method of claim 14, wherein the machine learning algorithm comprises a neural network.

16. A tangible, non-transitory, machine-readable medium storing instructions that when executed effectuate operations including:
training an algorithm using input output training pairs that describe prior financial information, prior visa information, prior student type information, and/or prior housing payment history information, for a population of international students and/or scholars affiliated with educational institutions in the United States;
inputting new financial information, new visa information, and/or new student type information for an international student or scholar to the algorithm;
determining, with the algorithm, relational data indicative of a financial capacity for the international student or scholar based on the new financial information, new visa information, and/or new student type information; and
determining, with the algorithm, based on the relational data, the new financial information, the new visa information, and/or the new student type information, the financial capacity of the international student or scholar to pay for housing in the United States while the international student or scholar is affiliated with an educational institution.

17. The medium of claim 16, the operations further comprising receiving, with the algorithm, later payment information for the international student or scholar indicating whether payments for the housing in the United States while the international student or scholar is affiliated with the educational institution have been made; and
iteratively updating, based on the later payment information, the training of the algorithm, such that the determining of the financial capacity of the international student or scholar to pay for housing in the United States while the international student or scholar is affiliated with the educational institution is automatically personalized for the international student or scholar over time.

18. The medium of claim 16, wherein determining the financial capacity of the international student or scholar to pay for housing in the United States while the international student or scholar is affiliated with the educational institution comprises determining a score.

19. The medium of claim 16, wherein the new financial information is weighted heaviest, the new visa information is weighted second heaviest, and the new student type information is weighted third heaviest by the algorithm for the determination of the financial capacity.

20. The medium of claim 16, wherein the new financial information comprises information from a Form I-20, a bank balance, scholarship information, sponsorship information, and/or employment information for the international student or scholar.

21. The medium of claim 16, wherein the new visa information comprises a visa type, a visa validity period, and/or a university program period for the international student or scholar.

22. The medium of claim 16, wherein the new student type information comprises an indication of whether the international student or scholar is an undergraduate or graduate student, and/or an indication of whether the international student or scholar is new versus transferring or continuing.

23. The medium of claim 16, wherein the relational data comprises an indication of whether the international student or scholar is permitted to work, whether a visa validity period is longer than a university program period, and/or whether the international student or scholar has excess funding compared to that required for attending university in the United States.

24. The medium of claim 16, wherein the algorithm comprises a machine learning algorithm.

25. The medium of claim 24, wherein the machine learning algorithm comprises a neural network.

26. A system for determining a financial capacity of an international university student, the system comprising one or more computers having one or more processors configured to effectuate operations comprising:
training an algorithm using input output training pairs that describe prior financial information, prior visa information, prior student type information, and/or prior housing payment history information, for a population of international students and/or scholars affiliated with educational institutions in the United States;
inputting new financial information, new visa information, and/or new student type information for the international student or scholar to the algorithm;
determining, with the algorithm, relational data indicative of the financial capacity for the international student or scholar based on the new financial information, new visa information, and/or new student type information; and
determining, with the algorithm, based on the relational data, the new financial information, the new visa information, and/or the new student type information, the financial capacity of the international student or scholar to pay for housing in the United States while the international student or scholar is affiliated with an educational institution.

27. The system of claim 26, the operations further comprising receiving, with the algorithm, later payment information for the international student or scholar indicating whether payments for the housing in the United States while the international student or scholar is affiliated with the educational institution have been made; and
iteratively updating, based on the later payment information, the training of the algorithm, such that the determining of the financial capacity of the international student or scholar to pay for housing in the United States while the international student or scholar is affiliated with the educational institution is automatically personalized for the international student or scholar over time.

28. The system of claim 26, wherein determining the financial capacity of the international student or scholar to pay for housing in the United States while the international student or scholar is affiliated with the educational institution comprises determining a score.

29. The system of claim 26, wherein the new financial information is weighted heaviest, the new visa information is weighted second heaviest, and the new student type information is weighted third heaviest by the algorithm for the determination of the financial capacity.

30. The system of claim 26, wherein the new financial information comprises information from a Form I-20, a bank balance, scholarship information, sponsorship information, and/or employment information for the international student or scholar.

31. The system of claim 26, wherein the new visa information comprises a visa type, a visa validity period, and/or a university program period for the international student or scholar.

32. The system of claim 26, wherein the new student type information comprises an indication of whether the international student or scholar is an undergraduate or graduate student, and/or an indication of whether the international student or scholar is new versus transferring or continuing.

33. The system of claim 26, wherein the relational data comprises an indication of whether the international student or scholar is permitted to work, whether a visa validity period is longer than a university program period, and/or whether the international student or scholar has excess funding compared to that required for attending university in the United States.

34. The system of claim 26, wherein the algorithm comprises a machine learning algorithm.

35. The system of claim 34, wherein the machine learning algorithm comprises a neural network.
